(19) United States
(12) Patent Application Publication
(10) Pub. No.: US 2003/0009762 A1
(43) Pub. Date: Jan. 9, 2003

(54) Method and apparatus for the display of selected images at selected times using an autonomous distribution system

(76) Inventors: Mark Edmund Hooper, Quebec (CA); Claire Langlois, Quebec (CA); Francois Cloutier, Quebec (CA)

Correspondence Address: Brouillette Kosie, 25th Floor, 1100 Rene Levesque Boulevard West, Montreal Quebec, H3B 5C9, CA

(21) Appl. No.: 09/937,078

(22) PCT Filed: Feb. 12, 2001
(86) PCT No.: PCT/CA01/00166

(30) Foreign Application Priority Data
Feb. 11, 2000 (CA) 2298358

(51) Int. Cl. H04N 7/173

(52) U.S. Cl. 725/91

(57) ABSTRACT

Internet Service Providers (ISPs) or proxies owned by ISPs collect and store information regarding particular users (100) in user profiles. Profiles may include demographic information, such as age, residence, and credit history, and may include web sites the user has accessed, time spent on each web site, and Internet searches the user performed. Profile information (304) may be utilized by the proxy (102) to target advertising, provided to a web server (104) so the web server (104) may target advertising, or used to customize a user's display. Profile information (304) may also be utilized to associate a cost with certain demographic information. The ISP may evaluate profile information (304) for inserting advertisements or customizing displays. Profile information (304) may also be sold to a third party. Thus, the profile and demographic information (304) can be utilized to individually customize information displayed to a client (100).

### BACKGROUND OF THE INVENTION

1. Field of the Invention

This invention relates to a method for the remote display of selected images at selected times and to an Autonomous Distribution System (ADS) and components thereof used with such method. This method and system offer an end-to-end solution for advertisers, retailers, television networks and other information providers wishing to access, via geographic, demographic and/or other selectors, a diverse network of remotely located electronic multimedia displays of varying format and capacity.

2. Description of Prior Art

Geographic, video and similar display systems are known in the art and are often used for advertising and information presentation. Multiple display presentation systems having a set of displays for jointly reproducing, either in still or continuous motion, successive sets of correlated images according to a desired and modifiable presentation program are known. Examples of such systems are shown in U.S. Pat. Nos. 5,335,081 (Yamaguchi et al.), 5,488,385 (Singhal et al.), 5,692,330 (Anderson), 5,694,141 (Chee), 5,933,154 (Howard et al.), 5,361,078 (Caine), 4,866,530 (Kalua), 4,800,376 (Suga et al.) and 4,760,388 (Tatsumi et al.)

### SUMMARY OF THE INVENTION

Introduction

A digital distribution control and presentation method and system is designed to offer an end-to-end solution for advertisers, retailers, television networks and other information providers wishing to access, via geographic, demographic and temporal selectors, a diverse network of remotely located electronic multimedia displays of varying format and capacity.

The fundamental concepts behind the “autonomous distribution system” are based upon analysis of the sales and presentation activity in the private multi-media industry. Typical clients for private broadcasts are retail store chains. The electronic content presented in a store chain is organized in a fashion similar to a television channel with content and advertising mixed together. However, while all stores in the chain may wish to have the same informative content, the advertising inserted in the channel may differ from store to store depending upon the stock, traffic and sales activity in a specific location. Thus, the ability to create broadly distributed channels, but with fine-grained differentiation in the advertising content of each channel based upon location or demographics is the goal of advertisers and retailers alike. The autonomous distribution system technology or the invention was designed with this functionality as the target objective.

As a distribution system, the autonomous distribution system is particularly effective at planning the transmission and maintenance of electronic files to globally distributed sites. It could be used by a television network wishing to send varying content (e.g. commercials, local announcements, etc . . . ) to its affiliated stations in different markets.

The system can be broken into four distinct activities:

Scheduling control and planning

Transmission planning and performance

Site presentation and control

Network monitoring tools and remote access.

Each activity in the system preferably has the following characteristics:

Completely autonomous standalone functionality

Optimised planning and implementation for reduced operation costs

Guarantee of service and active telemetry of system status.

The autonomous distribution system of the invention is based on a client-server architecture involving an independent autonomous Scheduling System connected to a plurality of display sub-systems, through a high bandwidth network which is controlled by a Transmission Control System.

The Scheduling System is also connected to individual workstations through a direct connection or through any appropriate network such as the Internet. Workstation operators can, via the Scheduling System, access the network of display sub-systems using geographic, demographic and temporal selectors to implement advertising and other distribution campaigns. Matrix planning is used to allow multiple campaigns to participate in overlapping sub-sets of display sites on the network.

Scheduling

Scheduling is performed using three different methods:

Method 1 (direct): this scheduling method allows workstation operators to access individual display sub-systems and schedule multimedia distribution and presentation at specific times and frequencies.

Method 2 (play list): this scheduling method causes a display subsystem to cycle through a play list of content.

Method 3 (coverage): coverage planning is a complex operation involving planning a multimedia campaign involving one or many display sub-systems. The optimisation is performed at two levels; display specific, and inter-display. This optimisation procedure takes into account the following sets of criteria:

A multilevel set of industry-specific conflict detection and avoidance or attraction involving presence and timing of advertising from competing or complementary industry members and conflicting industry interdictions. Conflicts are resolved on one display sub-system or between several display sub-systems in close proximity and even on one specific display screen in those cases where a display sub-system is capable of independently controlling a plurality of display screens. Conflict management may also involve restrictions on specific advertising content at certain locations during certain time periods.

Demographic reach targets for audience specification.

Multiple methods of optimisation of play list content within a working “day” period (a “day” need not be 24-hours).

Optimization of planning and implementation of multiple ads in complex campaigns.

Generation of display site list and presentations for multiples sites to achieve campaign targets.

Schedule planning for campaigns involving random migration of content on a portion of a targeted subset of the display sub-systems on the network during the campaign. This “roaming” campaign allows greater “first sight” coverage of a targeted demographic/geographic segment.

The system maintains two sets of scheduling data for each display screen in the network. The first set contains the available air-time “inventory” consisting of the maximum possible advertising time for each display screen. The second data set contains the actual presentation play lists. Since not all inventory is always sold, and the system must not show blank display screens to the audience, the system must translate from the actually sold inventory into the actual presentation schedule while safeguarding the original intention of the advertising campaign. Multiple methods of generating the actual presentation play lists from the inventory actually sold have been developed and implemented:

Method A—Generate a rotation of content showing exactly the order of content planned, but disregarding the original planned length of the rotation. Thus if one hour of air-time was originally for sale, but only 40 minutes has been sold, then the resultant play list will show a repeating 40 minute loop of unique content.

Method B—Generate a play list which maintains the original length and placement of the content, but fills in the empty spots in a manner consistent with the original intentions of the advertisers. This method is the most complex and involves filling in the unsold advertising spots with a combination of Public service spots and advertising taken from those advertisers present in the schedule and inserted in priority and proportion to their presence in the sold schedule. Thus an advertiser purchasing 50% of the inventory on a display screen will have a higher priority than one who purchased only 20% of the available space. The unsold space will then be filled in proportion to their purchase and priority In this way, the system safeguards the original intentions of the advertiser in term of market penetration and presentation priority while maintaining a professional display appearance.

Workstations

The planning workstations are linked to a Scheduling System and are programmed to allow non-experts to implement complex advertising and information campaigns according to targets previously planned by media specialists. The workstations use an optimised Graphical User Interface (GUI) to assist in the implementation of the campaigns.

The workstations support multiple levels of user privilege ranging from general access to supervisor level control. In this way the system allows multiple levels of verification before campaigns can be implemented on the display sub-systems network.

The campaign planning system (hereinafter the “CPS”) is a graphical tool, within the autonomous distribution system workstation interface, used to convert macroscopic Human-oriented advertising objectives into specific display and event schedules. The CPS takes the following factors into account when planning a campaign:

Demographic goals of campaign.

Geographic goals of campaign.

Budgetary restrictions of campaign.

Industry and presentation timetable restrictions.

Market Penetration.

Target audience size.

The CPS functions via an extensive database record maintained for each display screen or channel controlled by the autonomous distribution system. Each database record keeps data on such diverse elements as geographic and demographic groups, industry and timetable exclusions, financial costs and audience traffic patterns.

The workstation program allows the users to monitor the progression and achievement of the goals of specific advertising and information campaigns and the overall network. Complex campaigns and system status indicators are viewed using a 3-dimensional data cube designed to allow surface-type presentation of the activities of large volumes of data, campaigns and display activity.

A specialized web-browser version of the workstation called the “Direct-Access System” or “remote workstation” permits a sub-set of the workstation functionality to be accessible by service and sales operatives in the field. The remote workstations connect to the network via the Internet or other known means. Using this method, no special software is required on the operative's computer to access the Scheduling System.

Transmission Scheduling and Broadcasting

The Transmission Control System is the communications control hub for the entire system. It is responsible for delivering the content and commands determined by the Scheduling System to the specified set of display sub-systems. The Transmission Control System is responsible for the overall electromechanical health of the network. As such it performs the following tasks:

Receive content and commands from the Scheduling System.

Plan and execute an optimized transmission schedule designed to achieve just-in-time delivery of multimedia content at a minimum of cost and a maximum of reliability using whatever means of delivery are available.

Implement a dynamically shifting multicast/unicast transmission protocol for reduced communications costs and minimized bandwidth.

Encrypt/decrypt data for enhanced security.

Receive performance logs and display site telemetry for aggregations and forwarding to the Scheduling System.

The primary data communications mechanism used by the Transmission Control System to communicate with the display sub-systems is preferably via bi-directional VSAT technology using small remote-site dish antennas. However, the Transmission Control System is also capable of using any IP-based transmission technology such as Internet, ISDN and POTS lines.

The heart of the Transmission Control System is the transmission optimizer. This is a specific software solution designed to take in a diverse set of requests for content delivery to specific sites on a IP-based network and generate a transmission schedule which gives the maximum of efficiency and certainty of success, while using the minimum of delivery channel bandwidth. The transmission optimizer of the Transmission Control System allows the implementation of a Just-In-Time delivery over networks of varying topology.

Display Sub-Systems

The display sub-systems are responsible for implementing the content presentation on the schedule which was previously planned. Each display sub-system comprises one or more display screen(s) (the size and performance characteristics of which will depend on the needs of the site where it is to be installed) and a display control system which receives and stores the data received from the Scheduling System and is adapted to display the images on its associated display screen(s) in accordance with the play list. The display sub-systems preferably have the following characteristics:

Multi-channel presentation of multi-media content such as MPEG-1 and 2 and on-screen overlay of text and graphical images.

Data reception via VSAT, or other electronic transceiver technology.

Performance data-logging for transmission of “as-run” performance logs to the Transmission Control System from the display controller system.

Fully redundant mechanical and electronic operations.

Operate in either primary or team mode to implement multimedia concepts requiring screen resources greater than one display sub-system can muster. In this way a display sub-system can declare itself “site master” and receive or obtain content and or content location scheduling information for other display sub-systems. The site master will then forward and co-ordinate the activities of the team member display sub-systems.

An active configuration management protocol is built into the display sub-systems. This protocol allows the units to communicate via IP, RS232 or other means with industry standard equipment used with display sub-systems to create special effects such as lighting and sound control or video-wall support via synchronisation of the independent video outputs.

Contains an intelligent content management and acquisition capacity. Due to this capacity, the Scheduling System can function autonomously from the network and distribution management activity. The Scheduling System informs Display Controllers of their required activity. The Display Controllers then analyse the instructions and validate that they possess the resources necessary to perform said activities. If and when a data file is determined to be necessary, the Display Controller is then responsible for requesting the delivery of said file from the Transmission Control System within the available time period. It is this independent pushing of the desired state of the activity at the edge of the network, which in turn generates the pull of content from wherever it may be available that allows the system to be autonomous, efficient and reliable.

The Display Controller can also use the above capabilities to act as a digital content warehouse and communications access point for external sub-systems such as interactive kiosks and hosted applications developed by third parties. The autonomous “push-pull” of the Scheduling-Display-Transmission Control Systems allows the system to be equally efficient and useful for data distribution and maintenance activity as for advertising and digital presentation.

Network Monitoring Tools and Remote Access

The Scheduling System and the Transmission Control System support remote access for system monitoring and control. Using this mechanism, the following tools are implemented for remote access: main system data concentrator panels, and sales/marketing access programs using connection via the Internet or other known means.

Concentrator panels which are large format graphical displays running on independent computer systems are used in conjunction with each service and transmission center. Each concentrator panel shows the state of the overall system Two specific types of concentrator panels are used: the network activity monitor and the system status and transmission activity monitor.

The monitoring programs used to update the concentrator panels are capable of operating using direct LAN, Internet or other known connections to the system. This permits the system to be monitored by managers at remote sites using varying equipment.

The sales access programs allow sales and marketing personnel to plan and book time on the system without actually having to prepare content. The reduced bandwidth requirements permit the sales personnel to operate their stations at a customer site using an Internet connection. Each station can present the state of inventory and availability on the system. The sales personnel can begin and plan campaigns, and finally make sales proposals. The system then automatically forwards the instructions to the Scheduling System for the fully trained workstation operators to continue the required operations for implementation using the Scheduling Workstations.

There is, therefore, provided a digital presentation system which comprises:

a) an autonomous schedule planning server itself comprised of:

i) computer processor means for processing data;

ii) storage means for storing data on a storage medium,

iii) data transceiver means;

b) an autonomous transmission optimizing server itself comprised of:

i) computer processor means for processing data,

ii) storage means for storing data on a storage medium,

iii) data transceiver means;

c) at least one individual workstation itself comprised of:

i) computer processor means for processing data,

ii) graphical interface for campaign planning, execution and follow-up,

iii) means for multimedia data encoding and transcoding,

iv) storage means for storing data on a storage medium,

v) transceiver means;

d) at least one visual displays subsystem itself comprised of:

i) at least one visual display screen,

ii) a display controller connected to said visual display screen comprising:

computer processor means for processing data,

storage means for storing data on a storage medium,

multi-media content presentation means,

iii) data transceiver means;

e) a first data communication network connecting said schedule planning server, said transmission optimising server and said individual workstation(s) through their respective transceiver means;

f) a second data communication network connecting said transmission optimising server and said visual display subsystem(s) through their respective transceiver means;

g) first means for processing data to determine the availability of presentation time periods on each said visual display sub-system;

h) second means for processing data to select and reserve available presentation time period on each said visual display sub-system;

i) third means for processing data to associate one or more multimedia content to be displayed during each said reserved presentation time period;

j) first means for transmitting said multimedia content to the corresponding visual display sub-system;

k) second means displaying said multimedia content on the corresponding display screen during the corresponding presentation time period.

There is also provided a digital presentation system as described above further comprising first means for inputting and storing demographic data in relation to the geographic location of each visual display sub-system.

In a preferred embodiment, there is provided a method for the display of multimedia content on one or more display screens connected to one or more display controllers which are themselves connected to a scheduling server and a transmission server via a data communication network comprising the following steps:

a) selecting multimedia content to be displayed;

b) storing said content on the scheduling server;

c) selecting one of said display screens on which the content is to be displayed;

d) storing such display screen selection on said scheduling server,

e) selecting a time interval during which said content is to be displayed on said display screen;

f) storing said time internal selection on said scheduling server;

g) transmitting said stored content and said stored time interval selection to the display controller connected to said selected display screen;

h) displaying the selected content on the selected display screen during the selected time interval.

### DESCRIPTION OF THE DRAWINGS

FIG. 1 is a schematic representation of a first embodiment of an autonomous digital presentation system in accordance with the invention. The diagram shows a system involving several service bureaux each containing a Scheduling Server and a plurality of workstations connected via high-speed connection with a Transmission centre containing a Transmission Control System. The Transmission Control System is also connected via a secondary network with a diverse group of display sub-systems each containing one or more display screen(s).

FIG. 2 is a schematic representation of a complex display sub-system which may be used with the invention.

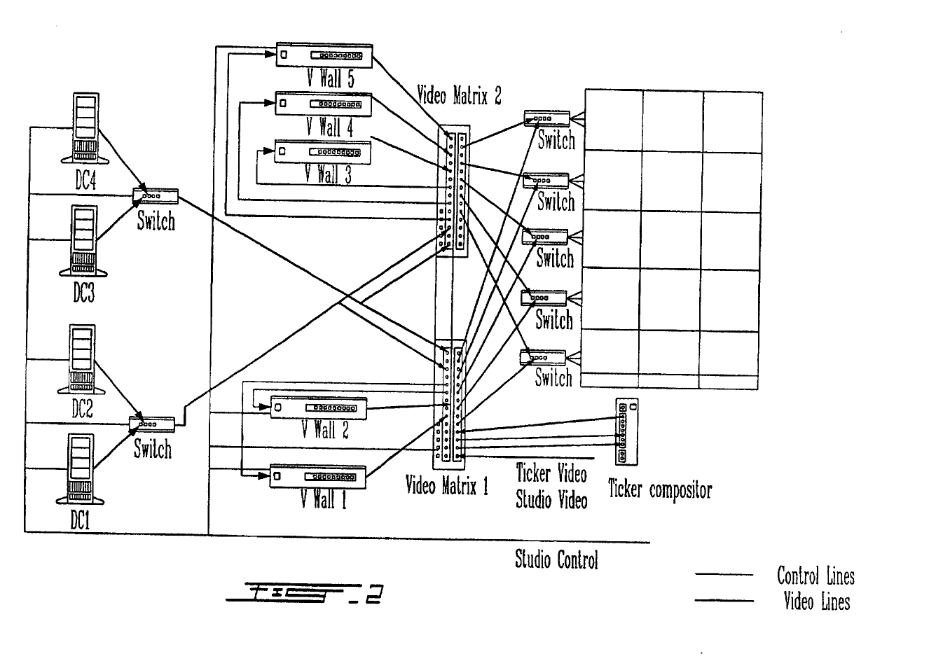

### DETAILED DESCRIPTION OF A PREFERRED EMBODIMENT

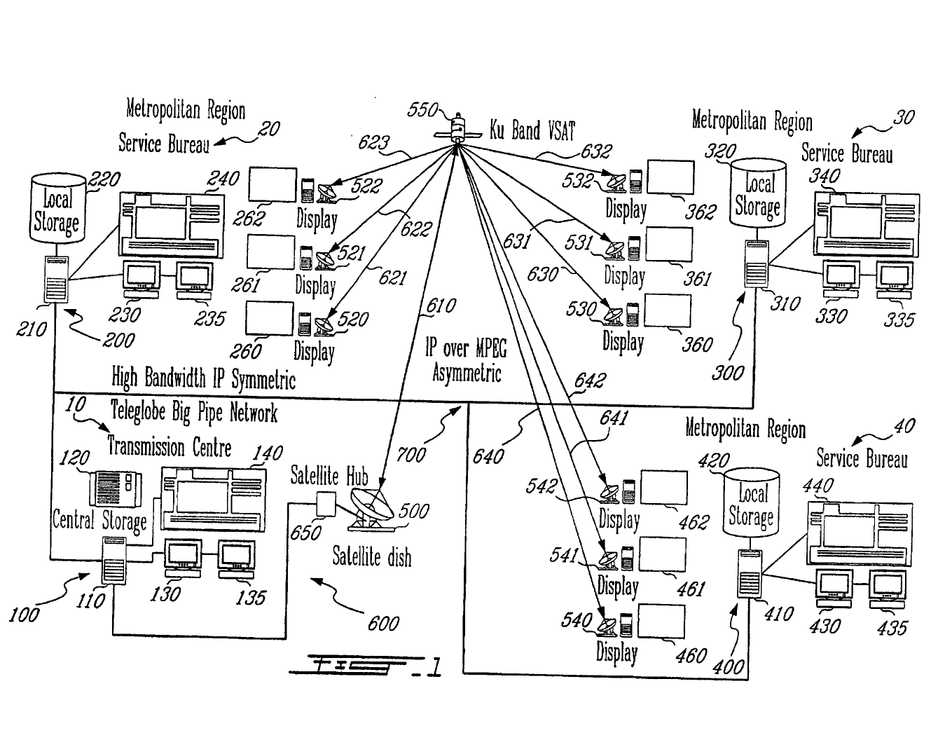

The digital presentation system shown in FIG. 1 comprises a Transmission Centre 10 and several Service Bureaux 20, 30 and 40 all controlling groups of display sub-systems. The Transmission Centre 10 comprises a Transmission Control System 100 comprising a CPU 110 a central storage 120, a first computer screen 130, a second computer screen 135, a large concentrator display panel 140 all connected to the CPU 110.

Similarly, there are provided Service Bureaux each containing Scheduling Servers 200, 300 and 400 respectively, each having a CPU, local storage, multiple workstations and one large concentrator display panel all connected to their respective CPUs 210,310 and 410.

All of the Scheduling Servers are connected via a high bandwidth network for example Teleglobe's high bandwidth network 700. This network of Scheduling Servers form the Scheduling System. Network 700 also connects all Scheduling Servers to the Transmission Control System 100.

A second network 600 connects the Transmission Control System to all the individual display sub-systems 520, 521, 522, 530, 531, 532, 540, 541 and 542 via a satellite dish 500 and a Ku band satellite 550.

Each display sub-system comprises a satellite dish, a CPU, a storage mechanism and at least one display screen adapted to be seen by passers-by.

A single Service Bureau can service a given metropolitan area in which a plurality of display sub-systems can be strategically deployed inside buildings or outside where they may replace traditional billboards.

Demographic data is gathered and inputted in the central storage 120 via workstations 200, 300 and 400. Such demographic data can either be global, for a given metropolitan region and/or specific for each display.

The needs and preferences of each advertiser and information provider who wishes to use the digital presentation system are gathered by the sales personnel and are inputted in the database maintained in the central storage 120 via the workstations and Scheduling Servers. These preferences include demographics, multimedia content, airtime preferences and budgetary constraints. All of these preferences and constraints are entered into the central storage 120 via the Scheduling Servers 200, 300 and 400. Each workstation operator can reserve air time for display sub-systems located in his/for metropolitan area or indeed in any other display sub-system connected to the Transmission Control System 100 via the network 600.

Each workstation operator also has the option of using optimisation software contained in the Scheduling Servers to suggest a schedule to the client which will take into consideration the aforesaid constraints (demographics, content, air time and budget).

Once the schedule is determined, it is inputted into the system which will then prepare a play list or schedule incorporating the needs of all the advertisers and information providers wishing to use each individual display sub-system. As each display performs its broadcast, a detailed log of all the relevant data is kept in the digital presentation system for future reference and to provide evidence to the advertisers and information providers to the effect that each given multimedia content was broadcast at a given site over a precise period of time.

A camera equipped with image recognition software can also be provided at each site and managed by the display sub-system to actually determine the number and characteristics of the actual audience during each broadcast. This information can be used for statistical and even billing purposes.

It is, of course, understood that the invention is not to be limited to the exact details of the representative digital presentation system and components thereof set forth above. A variety of departures from the foregoing disclosure may be made in order to conform to the design preferences or the requirements of each specific application of the invention. It is therefore appropriate that the invention be construed broadly and in a manner of consistent with the fair meaning or proper scope of the claims that follow.

For example, this invention may be used by a television network to schedule commercials or public announcements which are adapted to the needs of each local station.

What is claimed is:

1. A digital presentation system comprising:
a. a Scheduling Server itself comprising of:
i. computer processor means for processing data,
ii. storage means for storing data on a storage medium,
iii. data transceiver means;
b. a Transmission Control System itself comprising of:
i. computer processor means for processing data,
ii. storage means for storing data on a storage medium,
iii. data transceiver means;
c. at least one individual workstation itself comprising of:
i. computer processor means for processing data,
ii. graphical interface for campaign planning, execution and follow-up,
iii. storage means for storing data on a storage medium,
iv. media encoding/transcoding means,
v. transceiver means;
d. at least one visual display subsystem comprising of:
i. at least one visual display screen,
ii. a display controller connected to said visual display screen comprising:
(1) computer processor means for processing data,
(2) storage means for storing data on a storage medium,
(3) means for decoding and presenting multimedia content on one or more of said display screens,
iii. data transceiver means;
e. a first data communication network connecting said Scheduling Server said Transmission Control System and said individual workstation(s) through their respective transceiver means;
f. a second data communication network connecting said Transmission Control System and said visual display sub-system(s) through their respective transceiver means;
g. first means for processing data to determine the availability of air time periods on each said visual display sub-system;
h. second means for processing data to select and reserve available air time period on each said visual display sub-system;
i. third means for processing data to associate one or more multimedia content to be displayed to each said reserved air time period;
j. first means for transmitting said multimedia content to the corresponding visual display sub-system;
k. second means displaying said multimedia content on the corresponding display screen during the corresponding time period.

2. A visual presentation system as claimed in claim 1, further comprising first means for inputting and storing demographic data in relation to the geographic location of each visual display sub-system.

3. A digital presentation system as claimed in claim 1 further comprising:
a. second means for inputting and storing data related to the multimedia content preferences of each user of the digital presentation system;
b. third means for inputting data related to the air time period preferences of each user of the digital presentation system;
c. fourth means for processing data to determine for each visual display sub-system, the actual play list by optimally correlating said available air time periods, said air time period preferences, and said multimedia content preferences.

4. A digital presentation system as claimed in claim 3 wherein said fourth means for processing data comprises:
a. means to determine, for each said visual display and for a predetermined air time period, the duration of any unreserved air time period,
b. means to fill each said unreserved air time period with digital content which is compatible with the remaining multimedia content in the said corresponding predetermined air time period.

5. A digital presentation system as claimed in claim 2 further comprising:
a. second means for inputting and storing data related to the multimedia content preferences of each user of the digital presentation system;
b. third means for inputting data related to the air time period preferences of each user of the digital presentation system;
c. fourth means for processing data to determine for each visual display sub-system, the actual play list by optimally correlating said available air time periods, said air time period preferences, and said multimedia content preferences.

6. A digital presentation system as claimed in claim 5 wherein said fourth means for processing data comprises:
a. means to determine, for each said visual display and for a predetermined air time period, the duration of any unreserved air time period,
b. means to fill each said unreserved air time period with digital content which is compatible with the remaining multimedia content in the said corresponding predetermined air time period.

7. A digital presentation system as claimed in claim 2 further comprising:
a. second means for inputting and storing data related to the multimedia content preferences of each user of the digital presentation system;
b. third means for inputting data related to the air time period preferences of each user of the digital presentation system;
c. fourth means for inputting and storing data related to the demographic preferences of each user of the digital presentation system;
d. fourth means for processing data to determine for each visual display sub-system, the actual play list by optimally correlating said available air time periods, said air time period preferences, said multimedia content preferences, said demographic data and said demographic preferences.

8. A digital presentation system as claimed in claim 7 wherein said fourth means for processing data comprises:
a. means to determine, for each said visual display and for a predetermined air time period, the duration of any unreserved air time period,
b. means to fill each said unreserved air time period with digital content which is compatible with the remaining multimedia content in the said corresponding predetermined air time period.

9. A digital presentation system as claimed in claim 1 wherein said first data transmission network is a high bandwidth network.

10. A digital presentation system as claimed in claim 2 wherein said first data transmission network is a high bandwidth network.

11. A digital presentation system as claimed in claim 3 wherein said first data transmission network is a high bandwidth network.

12. A digital presentation system as claimed in claim 4 wherein said first data transmission network is a high bandwidth network.

13. A digital presentation system as claimed in claim 5 wherein said first data transmission network is a high bandwidth network.

14. A digital presentation system as claimed in claim 6 wherein said first data transmission network is a high bandwidth network.

15. A digital presentation system as claimed in claim 7 wherein said first data transmission network is a high bandwidth network.

16. A digital presentation system as claimed in claim 8 wherein said first data transmission network is a high bandwidth network.

17. A digital presentation system as claimed in claim 16 wherein said second data transmission network is a satellite network.

18. A digital presentation system as claimed in claim 16 wherein said first data transmission network is a television network.

19. A digital presentation system as claimed in claim 18 wherein said display screens are television sets.

20. A digital presentation system as claimed in claim 19 wherein said display controller is a television station.

21. A digital presentation system as claimed in claim 2 wherein said Scheduling Server storage means includes a database containing data records relating to each said display screen, including data relating to:
a. its geographical location,
b. available air time periods,
c. demographic data,
d. traffic patterns.

22. A digital presentation system as claimed in claim 21 further including data relating to budgetary restrictions.

23. A digital presentation system as claimed in claim 21 further including data relating to air time restrictions.

24. A digital presentation system as claimed in claim 21 further including data relating to target audience size.

25. A digital presentation system as claimed in claim 21 further including data relating to industry restrictions.

26. A digital presentation system as claimed in claim 21 further including data relating to market penetration.

27. A digital presentation system as claimed in claim 21 further including data relating to:
a. budgetary restrictions,
b. air time restrictions,
c. target audience size,
d. industry restrictions,
e. market penetration.

28. A method for the display of multimedia content on one or more display screens which are themselves connected to one or more display controllers to a scheduling server and a transmission control system via a data communication network comprising the following steps:
a selecting the multimedia content to be displayed;
b. storing said content on the scheduling server;
c. selecting one of said display screens on which the content is to be displayed;
d. storing such display screen selection on said scheduling server;
e. selecting a time interval during which said content is to be displayed on said display screen;
f. storing said time internal selection on said scheduling server;
g. transmitting said stored content and said stored time interval selection to the display controller connected to said selected display screen;
h. displaying the selected content on the selected display screen during the selected time interval.
